(19) United States
(12) Patent Application Publication
(10) Pub. No.: US 2024/0243404 A1
(43) Pub. Date: Jul. 18, 2024

(54) SIDE REINFORCING STRUCTURE OF A BATTERY CASE AND A VEHICLE INCLUDING THE SAME

(71) Applicants: HYUNDAI MOTOR COMPANY, Seoul (KR); KIA CORPORATION, Seoul (KR)

(72) Inventor: Jong Wook Lee, Cheonan-si (KR)

(73) Assignees: HYUNDAI MOTOR COMPANY, Seoul (KR); KIA CORPORATION, Seoul (KR)

(21) Appl. No.: 18/236,517

(22) Filed: Aug. 22, 2023

(30) Foreign Application Priority Data
Jan. 12, 2023 (KR) 10-2023-0004462

(51) Int. Cl. H01M 50/242; B60L 50/64; H01M 50/249

(52) U.S. Cl. CPC H01M 50/242; B60L 50/64; H01M 50/249; B60K 1/04

(57) ABSTRACT

A side reinforcing structure of a battery case includes reinforcing members each including at least one or more reinforcing ribs. The reinforcing members are continuously disposed to absorb collision energy that is applied to sides of a battery and to support the sides of the battery.

### CROSS REFERENCE TO RELATED APPLICATION

The present application claims priority to Korean Patent Application No. 10-2023-0004462, filed Jan. 12, 2023, the entire contents of which are incorporated herein by reference.

### BACKGROUND

### Field

The present disclosure relates to a structure for attenuating a collision of a vehicle.

### Description of the Related Art

An electric vehicle, which is a vehicle that can be driven by an electric motor, includes a chargeable high-voltage battery as an energy storage device for supplying power to an electric motor.

In the related art, a battery is mounted usually at the rear portion, for example, in the trunk of electric vehicles. However, these days, batteries are mounted under the floor of vehicles using a wide space because high capacity is required.

Electric vehicle batteries are often mounted with a protection structure to safeguard against damage that could cause a fire. This structure can protect the batteries from damage caused by a collision, or other factors.

The statements in this BACKGROUND section merely provide background information related to the present disclosure and may not constitute prior art.

### SUMMARY

The present disclosure has been made in an effort to solve the problems described above and an objective of the present disclosure is to provide a battery case with a side reinforcing structure that can mitigate the impact of a collision on a vehicle.

In particular, an objective of the present disclosure is to provide a side reinforcing structure of a battery case. In particular, the side reinforcing structure is effective in protecting a high-voltage battery of an electric vehicle.

The objectives of the present disclosure are not limited to those described above and other objectives not stated herein would be apparently understood by those who have ordinary skills in the art that the present disclosure belongs to (hereafter, ‘those skilled in the art’) from the following description.

The features of the present disclosure for achieving the objectives of the present disclosure and performing the characteristic functions of the present disclosure to be described below are as follows.

According to some embodiments of the present disclosure, a side reinforcing structure of a battery case includes absorption sections including at least one or more reinforcing ribs, and the absorption sections are continuously disposed to absorb collision energy, which is applied to sides of a battery, and to support the sides of the battery.

According to some embodiments of the present disclosure, a vehicle includes the side reinforcing structure of a battery case.

The present disclosure provides a side reinforcing structure of a battery case that has excellent performance in mitigating a collision of a vehicle, and a vehicle including the side reinforcing structure of a battery case.

In particular, according to the present disclosure, there is provided a side reinforcing structure of a battery case, the side reinforcing structure being able to effectively protect the battery of electric vehicles.

Effects of the present disclosure are not limited to those described above and other effects can be clearly recognized by those having ordinary skill in the art from the following description.

### BRIEF DESCRIPTION OF THE DRAWINGS

The above and other objectives, features and other advantages of the present disclosure should be more clearly understood from the following detailed description when taken in conjunction with the accompanying drawings, in which:

FIG. 1 is an exploded perspective view of a battery and a case that are installed under the floor of a vehicle;

FIG. 2 is a perspective view of a lower case of a battery according to the present disclosure;

FIG. 3A is a cross-sectional view taken along line S1-S1′ shown in FIG. 2;

FIG. 3B is a partial enlarged view of FIG. 3A;

FIGS. 4A and 4B show variation of the cross-sectional shape of a first reinforcing member of a side reinforcing structure of a battery case according to the present disclosure when a collision occurs;

FIGS. 5A and 5B show variation of a second reinforcing member of the side reinforcing structure of a battery case according to the present disclosure when a collision occurs;

FIG. 6 shows the cross-sectional shape of a third reinforcing member of the side reinforcing structure of a battery case according to the present disclosure when a collision occurs; and

FIG. 7 shows a battery protection state by a collision attenuation structure after a collision occurs.

### DETAILED DESCRIPTION

Description of specific structures and functions disclosed in embodiments of the present disclosure is only an example for describing the embodiments according to the concept of the present disclosure and the embodiments according to the concept of the present disclosure may be implemented in various ways. The present disclosure is not limited to the embodiments described herein and should be construed as including all changes, equivalents, and replacements that are included in the spirit and the range of the present disclosure.

It should be understood that, although the terms first and/or second, etc. may be used herein to describe various elements, but these elements should not be limited by these terms. These terms are used only to distinguish one element from another element. For instance, a first element discussed below could be termed a second element without departing from the right range of the present disclosure. Similarly, the second element could also be termed the first element.

When a component, device, element, or the like of the present disclosure is described as having a purpose or performing an operation, function, or the like, the component, device, or element should be considered herein as being “configured to” meet that purpose or to perform that operation or function.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Further, the terms used herein to describe a relationship between elements, that is, “between,” “directly between,” “adjacent,” or “directly adjacent” should be interpreted in the same manner as those described above.

Like reference numerals indicate the same components throughout the specification. The terms used herein are provided to describe embodiments without limiting the present disclosure. In the specification, a singular form includes a plural form unless specifically stated in the sentences. The terms “comprise” and/or “comprising” used herein do not exclude that another component, step, operation, and/or element exist or are added in the stated component, step, operation, and/or element.

The present disclosure is described hereafter in detail with reference to the accompanying drawings.

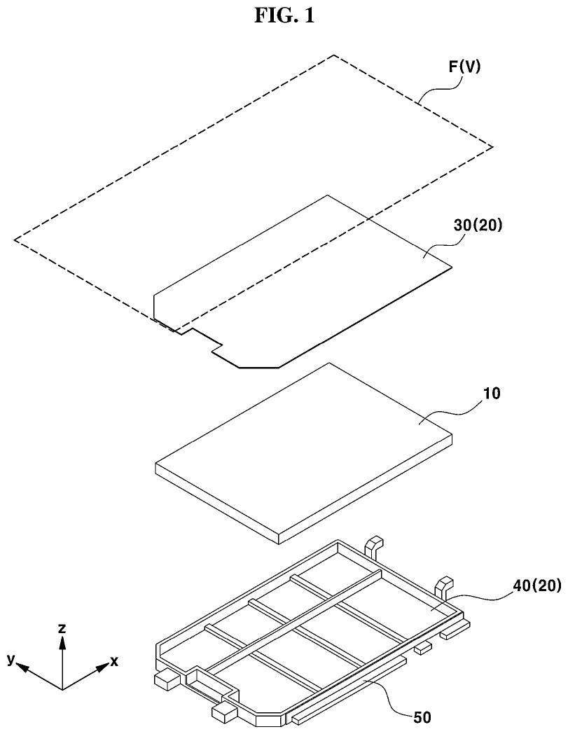

As shown in FIG. 1, a battery 10 of an electric vehicle “V” can be protected by a case 20 including an upper case 30 and a lower case 40. The battery 10 is mounted inside the lower case 40, and the upper case 30 covers the lower case 40, whereby the battery 10 in the case 20 is protected.

The case 20 assembled with the battery 10 may be mounted at the lower portion of the electric vehicle V. For example, the case 20 may be mounted under a center floor “F” of the electric vehicle V. The case 20 has a mounting portion 50, so the case 20 can be coupled to the electric vehicle V by bolts, etc.

The mounting portion 50 is a portion that connects the assembled case 20 and the battery 10 to the electric vehicle V. The mounting portion 50 may dominantly influence a collision performance of the battery 10 in the event of a collision, particularly, a side collision. The mounting portion 50 is provided in various shapes in consideration of the package of vehicles. However, such a difference in shape may influence collision performance.

In one embodiment of the present disclosure, a collision mitigation structure can provide effective collision performance even under a limited condition in which a shape depends on the package of vehicles.

In particular, the present disclosure provides a battery protection device having maximized collision performance by applying a side reinforcing structure of a battery case inside a mounting portion. The side reinforcing structure of a battery case according to the present disclosure may be applied also to other structures of a vehicle to which shock is applied besides the mounting portion of the battery case.

Further, the present disclosure provides a side reinforcing structure of a battery case, the side reinforcing structure having excellent structural rigidity together with maximized collision performance.

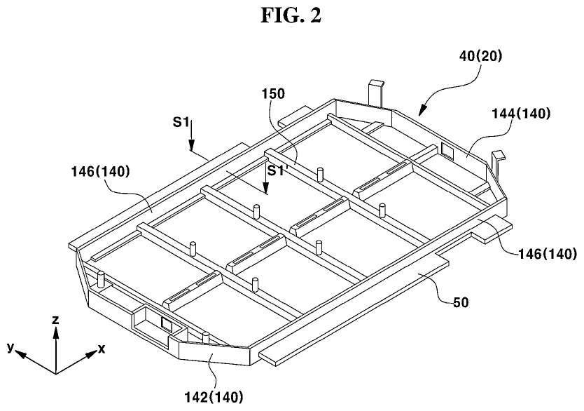

Referring to FIG. 2, an x axis represents the longitudinal direction of an electric vehicle V, a y axis represents the lateral direction of the electric vehicle V, and a z axis represents the vertical direction of the electric vehicle V.

The lower case 40 of the battery 10 includes walls 140. The walls 140 are configured to protect the battery 10 from the outside. The walls 140 include a front wall 142, a rear wall 144, and a pair of side walls 146. A plurality of internal members 150 is disposed in the space defined by the walls 140. The internal members 150 enable every module constituting the battery 10 to be mounted. A plurality of ribs 148 may be disposed inside the side walls 146.

As described above, the mounting portion 50 serves to absorb a collision in a side collision. However, a load transmission path depends on the internal structure of the mounting portion 50, so collision performance may depend on the cross-sectional shape of the mounting portion 50. The internal structure of the mounting portion 50 absorbs force that is applied from the outside or supports the case 20 against an external force, so transmission of external force can be controlled by changing the structure of the mounting portion 50, that is, by applying the side reinforcing structure of a battery case according to the present disclosure.

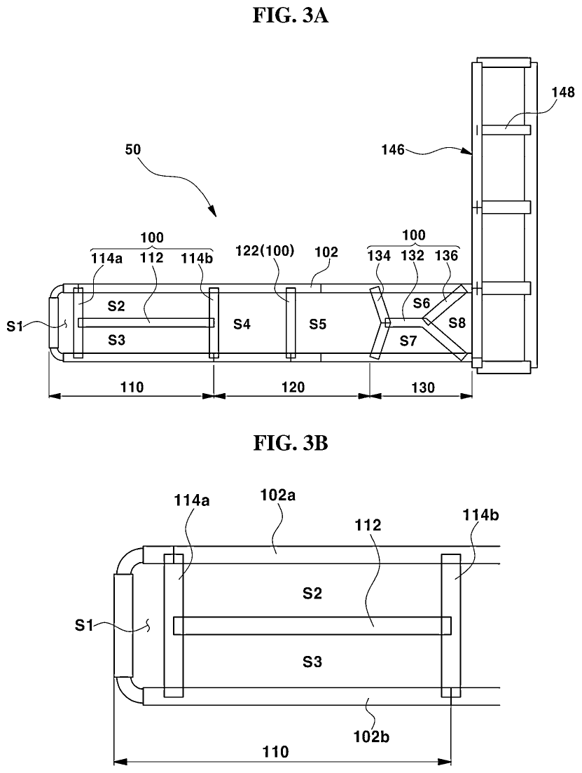

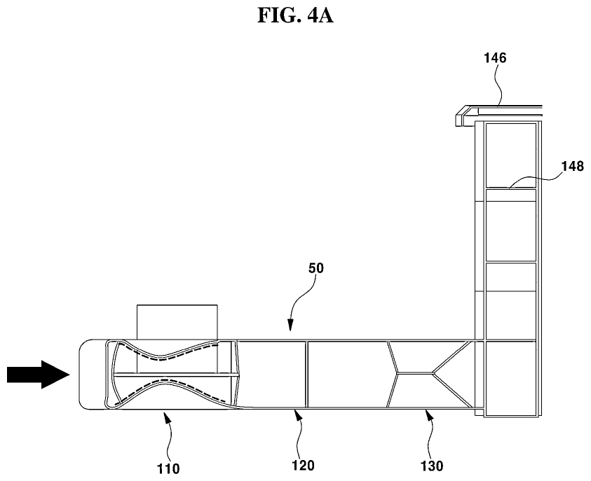

FIGS. 3A and 3B are cross-sectional views of the mounting portion 50 and the side walls 146 taken along line S1-S1′ of FIG. 2. As shown in FIGS. 3A and 3B, the mounting portion 50 may extend outward in the lateral direction (y axis) from the side wall 146 of the lower case 40. In an embodiment, the mounting portion 50 may be provided on the front wall 142 or the rear wall 144 of the case 40.

According to the present disclosure, the side reinforcing structure of a battery case includes spaces S1, S2, S3, S4, S5, S6, S7, S8 and a plurality of structure members 100 therein. The spaces S1, S2, S3, S4, S5, S6, S7, S8 and the structure members 100 may be surrounded by an outer wall 102. For example, the side reinforcing structure of a battery case according to the present disclosure may be applied to the mounting portion 50.

The spaces S1, S2, S3, S4, S5, S6, S7, S8 and the structure members 100 in the mounting portion 50 are configured to absorb external force that is applied to the mounting portion 50 and/or support the mounting portion 50 against external force. In detail, according to an embodiment of the present disclosure, the mounting portion 50 includes absorption sections 110, 120 and/or a third reinforcing member 130.

In general, when structures collide, the structures absorb the collision while deforming, or hard structures can withstand the collision. According to the present disclosure, the mounting portion 50 including the side reinforcing structure of a battery case has been designed to be able to both absorb and withstand a collision in one structure.

According to an embodiment of the present disclosure, the mounting portion 50 may include two absorption sections 110, 120 and/or one third reinforcing member 130. In an embodiment, the absorption sections 110,120 and the third reinforcing member 130 are continuously formed. For example, the absorption sections 110, 120 and the third reinforcing member 130 may be continuously formed inside the outer wall 102.

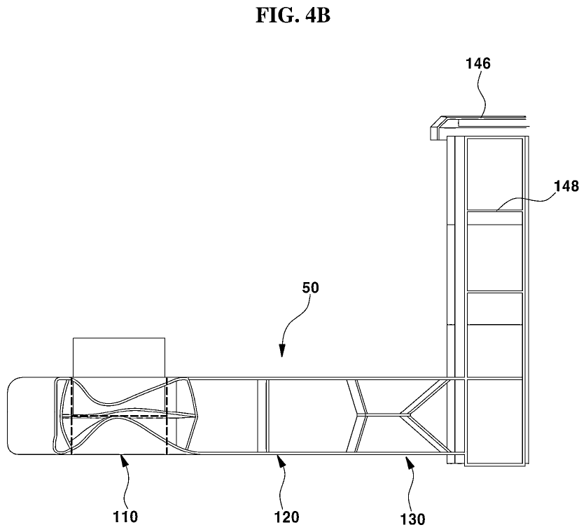

The first reinforcing member 110 is configured to absorb a collision force by deforming when a collision force is input in the direction of an arrow, as shown in FIG. 4A.

The first reinforcing member 110 includes a plurality of ribs 112, 114a, 114b for inducing a specific shape after a collision. A second reinforcing rib 112 is disposed in the space inside the outer wall 102 to extend in the lateral direction (y axis). The first reinforcing ribs 114a, 114b are coupled to both ends of the second reinforcing ribs 112, and both ends of the first reinforcing ribs 114a, 114b are coupled to the outer wall 102. Accordingly, the cross-sectional shape of the first reinforcing member 110 may have an H shape with top and bottom closed by the mounting portion 50.

The first reinforcing member 110 includes spaces S1, S2, S3. The space S1 is defined between the outer wall 102 and the first reinforcing rib 114a. The first reinforcing member 110 can more effectively absorb a collision due to presence of the first space S1. The space S2 may be defined over the second reinforcing rib 112 by the outer wall 102 and the first reinforcing ribs 114a, 114b. The space S3 may be defined under the second reinforcing rib 112 by the outer wall 102 and the first reinforcing ribs 114a, 114b.

When a collision force is input, the space S1 primarily absorbs the collision force. In particular, the first space S1 enables the first reinforcing member 110 to effectively withstand the collision force. In detail, the first space S1 enables the H shape, which is formed by the first reinforcing ribs 114a, 114b and the second reinforcing rib 112, to be maintained even while shock is applied to the first reinforcing member 110. The first reinforcing ribs 114a, 114b and the second reinforcing rib 112 forming the H shape can maintain the shape due to existence of the first space S1 even though shock is continuously applied. A portion 102a of the outer wall 102 defining the top of the space S2 of the first reinforcing member 110 and a portion 102b of the outer wall defining the bottom of the space S3 are deformed concavely toward the second reinforcing rib 112 while shock is applied, thereby being able to make the H shape more conspicuous. Accordingly, the first reinforcing member 110 having the H shape can support the structure against the collision absorbed by the portions 102a, 102b. According to the present disclosure, the first reinforcing member 110 deforms into a predetermined specific shape after a collision so that the deformed shape withstands the collision.

As shown in FIG. 4B, the shape deformed by an input collision force can have a substantially H shape. According to the present disclosure, the deformed H shape primarily withstands collision from the outside. In other words, the first reinforcing member 110 can support the case 20 against collision while absorbing the collision.

The second reinforcing member 120 is connected to the first reinforcing member 110 and can receive shock that is transmitted from the first reinforcing member 110.

The second reinforcing member 120 may include one or more reinforcing ribs. In an embodiment, a third reinforcing rib 122 may be disposed inside the outer wall 102 at a predetermined distance from the first reinforcing rib 114b substantially parallel to the vertical direction (z axis). In this case, a fourth space S4 is defined between the first reinforcing rib 114b and the third reinforcing rib 122. The second reinforcing member 120 may include a space S5 defined between the second reinforcing member 120 and the third reinforcing member 130. Both ends of the third reinforcing rib 122 may be coupled to the mounting portion 50 and the outer wall 102.

Although one reinforcing rib 122 is shown in figures, a plurality of reinforcing ribs 122 may be provided. When a plurality of reinforcing ribs 122 is provided, the reinforcing ribs 122 are spaced a predetermined gap apart from each other, and the larger the number of the reinforcing ribs 122, the smaller the gaps between the reinforcing ribs 122.

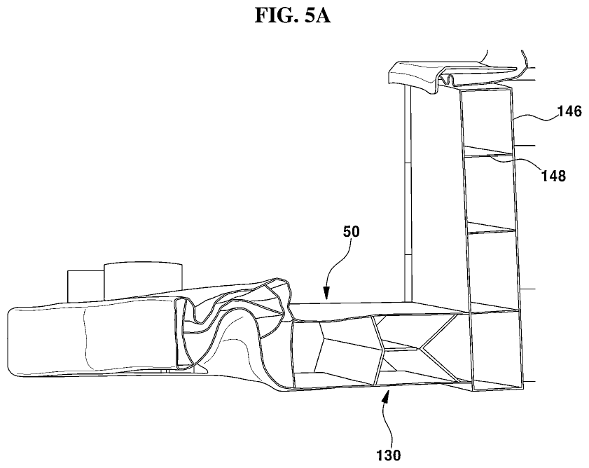

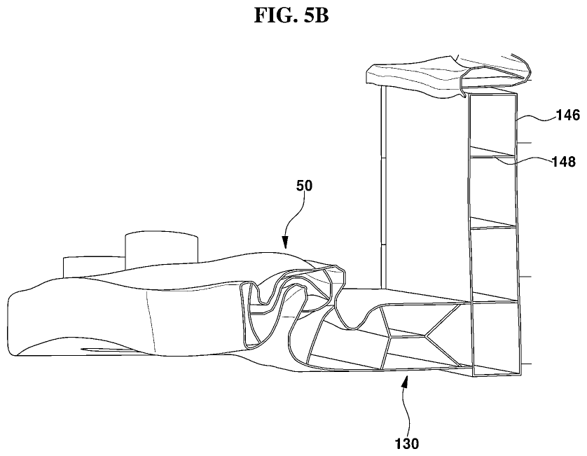

As shown in FIGS. 5A and 5B, the second reinforcing member 120 is configured to additionally absorb a collision when the collision is primarily absorbed and withstood by the first reinforcing member 110. The third reinforcing rib 122 is provided to be able to absorb more shock. The third reinforcing rib 122 enables the mounting portion 50 to move in the same direction and increase the degree of energy absorption.

The third reinforcing member 130 extends from the second reinforcing member 120 and is disposed adjacent to the side wall 146 to be close to the side wall 146 in comparison to the second reinforcing member 120. The third reinforcing member 130 may include, as structure members 100, a fourth reinforcing rib 132, a fifth reinforcing rib 134, and a sixth reinforcing rib 136. The fourth reinforcing rib 132 extends in the lateral direction (y axis) from the mounting portion 50. The fifth reinforcing rib 134 and the sixth reinforcing rib 136 are coupled to both ends of the fourth reinforcing rib 132, respectively. Both ends of the fifth reinforcing rib 134 and the sixth reinforcing rib 136 are coupled to the mounting portion 50 or the outer wall 102. Accordingly, spaces S6 and S7 are defined over and under the fourth reinforcing rib 132, respectively, by the outer wall 102, the fifth reinforcing rib 134, and the sixth reinforcing rib 136. A space S8 is defined between the sixth reinforcing rib 136 and the side wall 146.

In an embodiment, the fifth reinforcing rib 134 and the sixth reinforcing rib 136 each may be connected to the mounting portion 50 at a predetermined angle. In other words, at least one of the fifth reinforcing rib 134 and the sixth reinforcing rib 136 may bend at the fourth reinforcing rib 132. When a reinforcing member bends in this way, it is possible to more effectively withstand a collision.

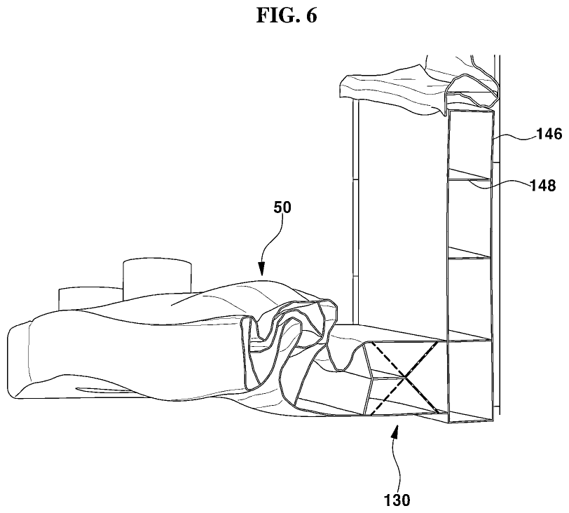

As shown in FIG. 6, the third reinforcing member 130 is positioned between the second reinforcing member 120 and the side wall 146. Accordingly, the third reinforcing member 130 enables the mounting portion 50 to support the case 20 finally one more time against a collision. For effective supporting, the cross-section of the third reinforcing member 130 may have a substantially×shape.

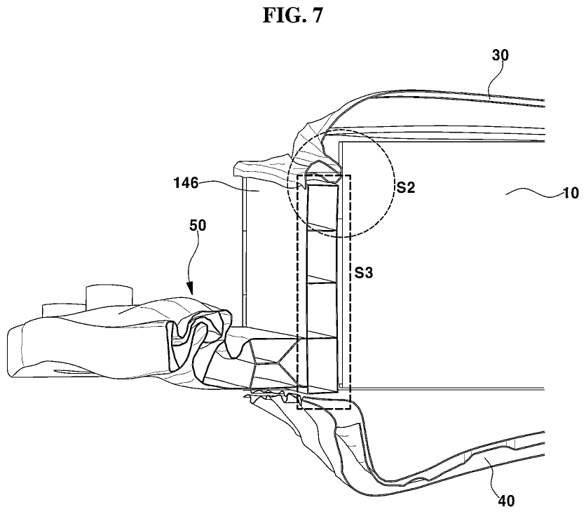

As shown in FIG. 7, according to the present disclosure, it is possible to remarkably reduce the level of deformation in comparison to the related art. According to the shapes in the related art, there is a physical contact between the case 20 and the battery 10 after a collision; however, according to the present disclosure, the case 20 may not come into physical contact with the battery 10 even after a collision. Further, it can be seen that a collision is not transmitted to the side wall 146 even after the collision, so there is little deformation (S3).

According to the present disclosure, an effect of reducing weight is provided even though the collision performance is improved in comparison to the related art, so it is possible to induce an economic effect.

The side reinforcing structure of a battery case according to the present disclosure is formed at the mounting portion 50 of the case 20 for mounting the battery 10 on an electric vehicle V in the above description. However, the side reinforcing structure of a battery case according to the present disclosure can be applied not only to the mounting portion 50 of the case 20, but to other members that are in charge of a collision. Further, the side reinforcing structure can be applied also to other collision absorbing or supporting structures that are in charge of a collision in addition to the case 20 of the battery 10.

It should be apparent to those having ordinary skill in the art that the foregoing present disclosure is not limited by the foregoing embodiments and the accompanying drawings, and various modifications and changes may be made without departing from the scope and spirit of the present disclosure.

What is claimed is:

1. A side reinforcing structure of a battery case, comprising:
reinforcing members each including at least one or more reinforcing ribs are continuously disposed and configured to absorb collision energy that is applied to sides of a battery and to support the sides of the battery.

2. The side reinforcing structure of claim 1, wherein the reinforcing members have different shapes and are laterally spaced apart from each other in the reinforcing structure.

3. The side reinforcing structure of claim 1, wherein the reinforcing members include a first reinforcing member, a second reinforcing member, and a third reinforcing member.

4. The side reinforcing structure of claim 3, wherein the first reinforcing member is configured to absorb the collision energy and provide a supporting force against the collision energy.

5. The side reinforcing structure of claim 3, wherein the first reinforcing member has a top and a bottom that are defined by an outer wall of the reinforcing structure, and
includes:
at least two first reinforcing ribs connecting the top and the bottom; and
a second reinforcing rib connecting the at least two first reinforcing ribs.

6. The side reinforcing structure of claim 5, wherein the second reinforcing rib is longer than the at least two first reinforcing ribs.

7. The side reinforcing structure of claim 3, wherein a cross-section of the first reinforcing member has an H shape having substantially closed top and bottom.

8. The side reinforcing structure of claim 3, wherein a space is defined between an outermost side of the reinforcing structure and the first reinforcing member.

9. The side reinforcing structure of claim 3, wherein the second reinforcing member is configured to absorb collision energy that is transmitted through the first reinforcing member.

10. The side reinforcing structure of claim 3, wherein the second reinforcing member includes at least one or more third reinforcing ribs vertically disposed inside an outer wall of the reinforcing structure.

11. The side reinforcing structure of claim 3, wherein the third reinforcing member is configured to provide a supporting force against collision energy that is transmitted through the second reinforcing member.

12. The side reinforcing structure of claim 3, wherein the third reinforcing member is configured to have a substantially X-shaped cross-section.

13. The side reinforcing structure of claim 3, wherein the third reinforcing member includes:
a fourth reinforcing rib laterally disposed in the reinforcing structure;
a fifth reinforcing rib connected to a first end of the fourth reinforcing rib and connected to an outer wall of the reinforcing structure; and
a sixth reinforcing rib connected to a second end of the fourth reinforcing rib and connected to the outer wall.

14. The side reinforcing structure of claim 3, wherein the first reinforcing member, the second reinforcing member, and the third reinforcing member are disposed sequentially inward from an outermost side of the reinforcing structure.

15. A vehicle comprising:
a battery case having a side reinforcing structure,
wherein the side reinforcing structure includes: reinforcing members each including at least one reinforcing rib are continuously disposed and configured to absorb collision energy that is applied to sides of a battery and support the sides of the battery.
